(19) United States
(12) Patent Application Publication
(10) Pub. No.: US 2007/0261520 A1
(43) Pub. Date: Nov. 15, 2007

(54) Wrench with outstanding grip

(76) Inventors: Chiou-Mai Chang, Taichung (TW); Yueh-Li Wang, Taichung (TW)

Correspondence Address: Chiou-Mai Chang, Suite 2, No. 37, Ching Dau First Street, Taichung, 404, TW

(21) Appl. No.: 11/432,202

(22) Filed: May 12, 2006

(51) Int. Cl. B25B 23/16; B25G 1/00; B25B 13/00

(52) U.S. Cl. 81/177.1; 81/125.1

(57) ABSTRACT

The present invention relates to a wrench of hand tool comprising a grip wherein at least one end of the grip is a driving head, and there is a sunken area on the surface of the grip. The sunken area is filled with many convexities and intensive knurl is implemented and embossed mark is established, the embossed mark being surrounded with the intensive knurl is visually outstanding so that the marks are outstanding of visual identification meanwhile the purpose of comfort and firmness in grip is achieved.

### FIELD OF THE INVENTION

The present invention relates to a wrench of hand tool wherein the grip has a sunken area which is filled with many convexities and convex marks so that the marks are outstanding of visual identification meanwhile the purpose of comfort and firmness in grip is achieved.

### BACKGROUND OF THE INVENTION

A conventional wrench is shown on FIG. 18. Normally, a conventional wrench would have been processed with either reflexible or non-reflexible surface treatment; which means the body 20, grip 21, mark area 22, mark 221 and all other areas are either reflexible or non-reflexible. Defects of a conventional wrench are described as follows:

1. Since the surface treatment is applied to the whole set of the wrench, the mark 221 and the body 20 are in the same condition; besides, the mark area 22 is not wide enough to have bigger mark 221, therefore the mark 221 is not easy to be identified with the body 20. When an operator is working at a dim place such as inside an engine compartment of an automobile, varieties of wrenches are not easy to be identified and then operations are bothered.

2. Since the whole set of the wrench has either reflexible surface or non-reflexible surface except the two driving ends, surface of the wrench is in a flat and smooth condition without substance to create enough friction to avoid getting loose in hand when operating.

3. In manufacturing process of the wrench, the mark area 22 and the mark 221 are generally forged to form with use of jigs. After certain numbers of the forging process, the jigs are likely damaged of abrasion with the body 20, cracks are easily coming out on the edge of the mark area 22 and in between the mark area 22 and the mark 221, and then productions are fault.

The present invention is an improvement on the shortcomings of the conventional wrench described above.

### SUMMARY OF THE INVENTION

The present invention relates to structural improvement of a wrench which includes a body with its grip in appropriate length, a sunken area in appropriate shape and depth for mark on one side of the grip, intensive plurality of knurls and embossed mark inside the sunken area; the surface of the embossed mark are not the same as that of the knurl in the sunken area, but the same as that of the grip, therefore the mark is outstanding of visual identification.

### BRIEF DESCRIPTION OF THE DRAWINGS

FIG. 1 is a 3-dimensional diagram of the first embodiment of the invention;

FIG. 2 is a cross-section view of the first embodiment of the invention;

FIG. 3 is a 3-dimensional diagram of the second embodiment of the invention;

FIG. 4 is a cross-section view of the second embodiment of the invention;

FIG. 5 is a cross-section view of the third embodiment of the invention;

FIG. 6 is a cross-section view of the fourth embodiment of the invention;

FIG. 7 is a cross-section view of the fifth embodiment of the invention;

FIG. 8 is 3-dimensional diagram of the sixth embodiment of the invention;

FIG. 9 is a 3-dimensional diagram of the seventh embodiment of the invention;

FIG. 10 is a 3-dimensional diagram of the eighth embodiment of the invention;

FIG. 11 is a 3-dimensional diagram of the ninth embodiment of the invention;

FIG. 12 is a 3-dimensional diagram of the tenth embodiment of the invention;

FIG. 13 is a partial enlarged diagram of the tenth embodiment of the invention;

FIG. 14 is a 3-dimensional diagram of the eleventh embodiment of the invention;

FIG. 15 is a 3-dimensional diagram of the twelfth embodiment of the invention;

FIG. 16 is a 3-dimensional diagram of the thirteenth embodiment of the invention;

FIG. 17 is a 3-dimensional diagram to show the grip of the wrench of the invention, and

FIG. 18 is a 3-dimensional diagram of the conventional wrench.

### DETAILED DESCRIPTION OF THE PREFERRED EMBODIMENT

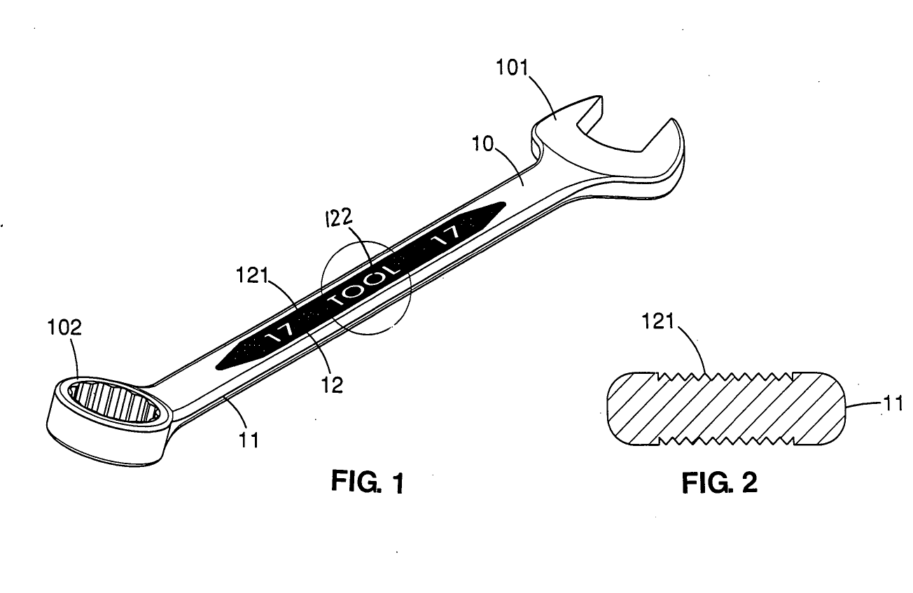

Referring to FIGS. 1 and 2, the wrench 10 of the present invention comprises a grip 11 which has two ends and a longitudinal axis connecting with two ends, and at least one end is a driving head, this embodiment shows the grip has two driving heads on both ends, one is an open end driving head 101 and the other is a box end driving head 102; the grip has two flat surfaces and there is at least one mark area in appropriate width and length on the surface of the grip 11, the mark area includes a sunken area 12 with appropriate depth wherein intensive plurality of knurls 121 is implemented therein and at lease one embossed mark 122 is established therein, the embossed mark 122 being surrounded with the intensive plurality of knurls 121 is visually outstanding. The embodiment shows the top of the plurality of knurls 121 and the surface of the grip 11 are in same level, the embossed mark 122 inside of the sunken area 12 can be letter, symbol or graph, the top of the embossed mark 122 and the surface of the grip 11 can be in same level.

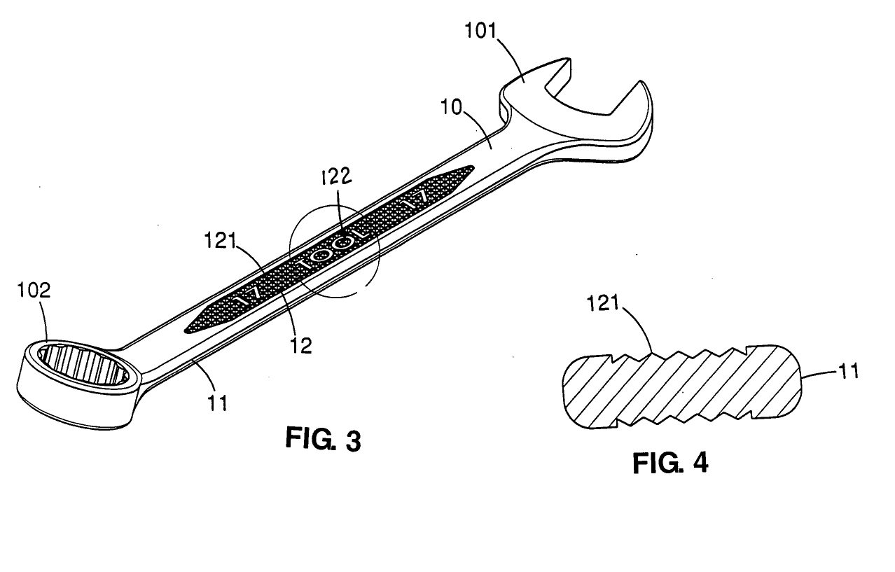

Referring to FIGS. 3 and 4, the second embodiment of the present invention shows larger scale of knurl 121 inside of the sunken area 12 by using press forming such that more friction would be created when gripping.

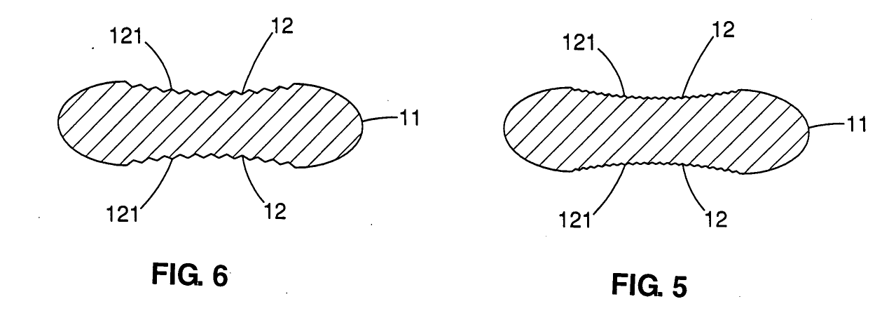

Referring to FIG. 5, the third embodiment of the present invention shows that the cross section of the grip 11 is shaped oval, on which the sunken area 12 is a concaved curve and the knurl 121 is in smaller scale.

Referring to FIG. 6, the fourth embodiment of the present invention shows that the cross section of the grip 11 is shaped oval, on which the sunken area 12 is a concaved curve and the knurl 121 is in larger scale.

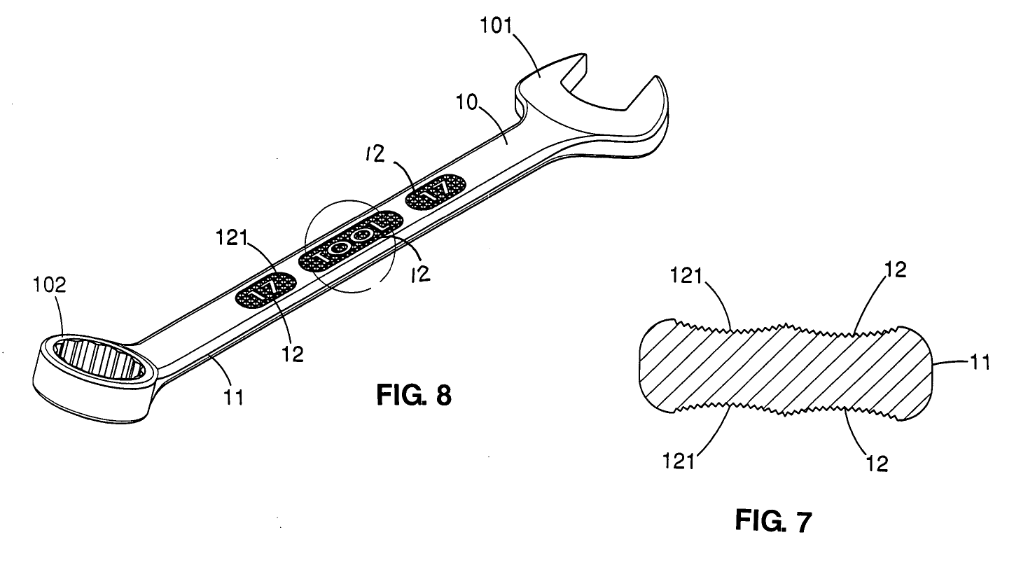

Referring to FIG. 7, the fifth embodiment of the present invention shows that the cross section of the bottom of the sunken area 12 is a conjunction of several concaved curves.

Referring to FIG. 8, the sixth embodiment of the present invention shows that there are three mark areas, i.e. three sunken areas 12 on the grip 11.

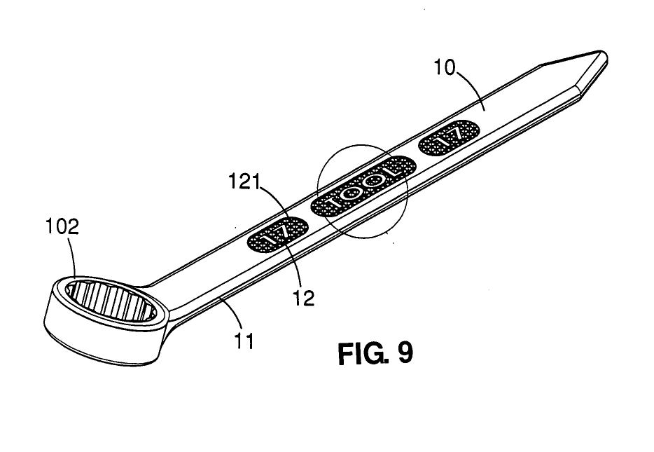

Referring to FIG. 9, the seventh embodiment of the present invention shows that the grip 11 has a driving head 102 at one end.

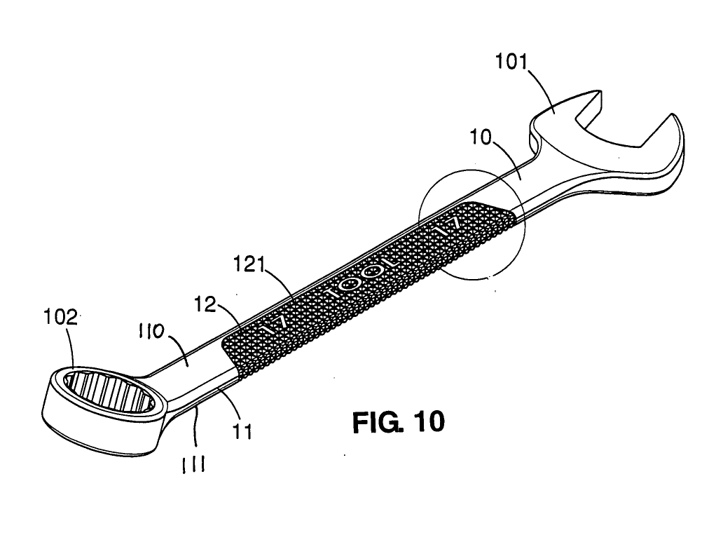

Referring to FIG. 10, the eighth embodiment of the present invention shows that the grip 11 is flat and wide with two flat grip surfaces 110 and 111, and the mark area extends onto one side of the grip surface 110/111.

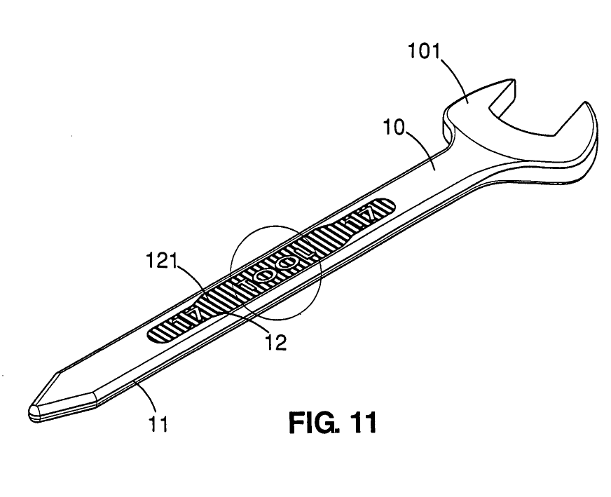

Referring to FIG. 11, the ninth embodiment of the present invention shows that each of the plurality of knurls 121 inside of the sunken area 12 is in striped shape that is vertical to the extending direction of the longitudinal axis of the wrench.

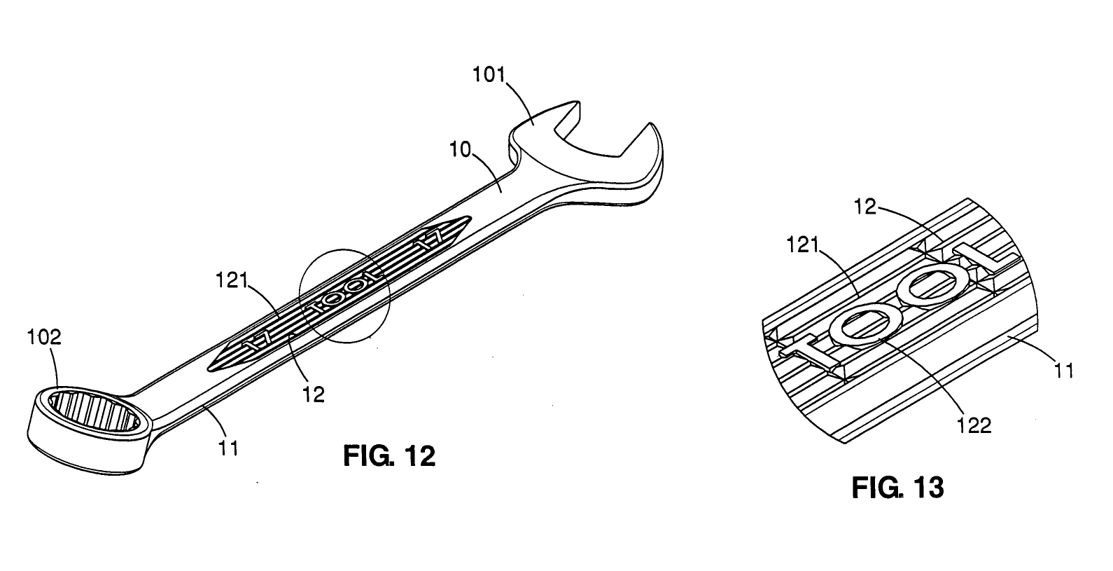

Referring to FIG. 12 and 13, the tenth embodiment of the present invention shows that each of the plurality of knurls 121 inside of the sunken area 12 is in striped shape which extending direction is parallel to the direction of the longitudinal axis of the wrench.

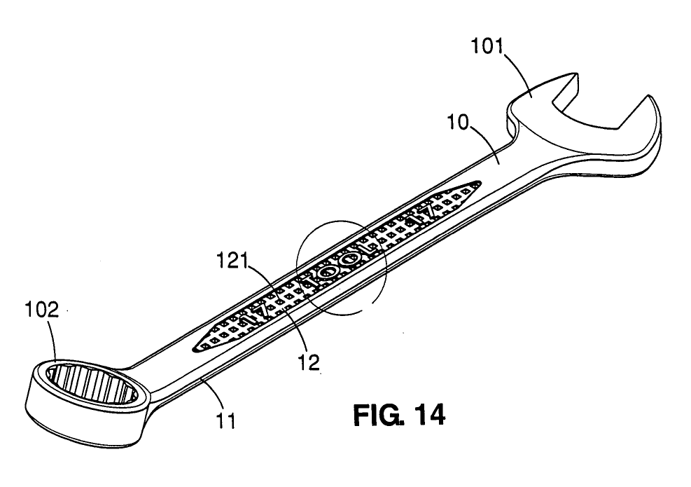

Referring to FIG. 14, the eleventh embodiment of the present invention shows that the knurl 121 inside of the sunken area 12 has bigger spacing between each knurl.

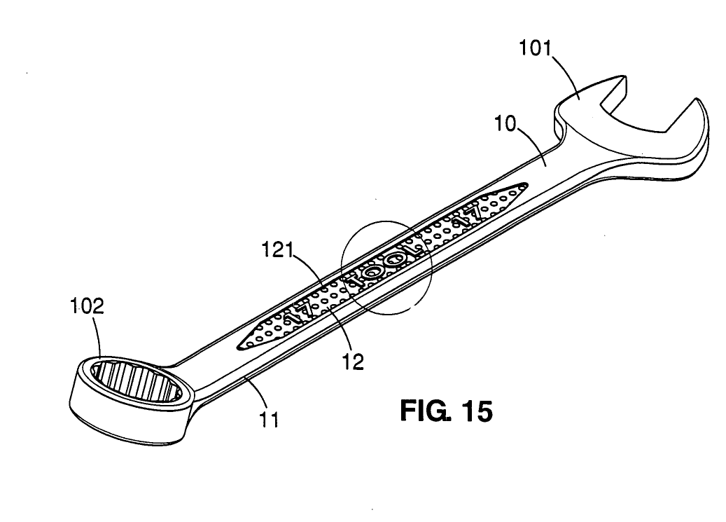

Referring to FIG. 15, the twelfth embodiment of the present invention shows that the knurls 121 inside of the sunken area 12 are dot knurls.

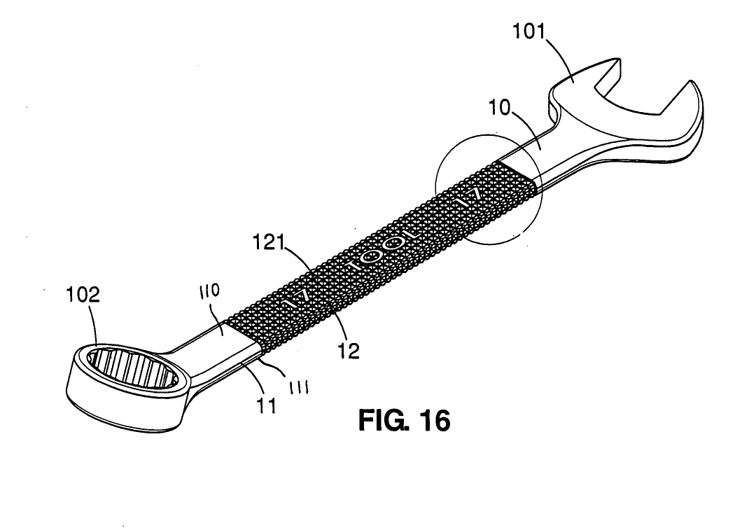

Referring to FIG. 16, the thirteen embodiment of the present invention shows that the grip 11 is flat and wide with two flat grip surfaces 110 and 111, and the sunken area 12 extends onto both sides of the grip surface 110/111.

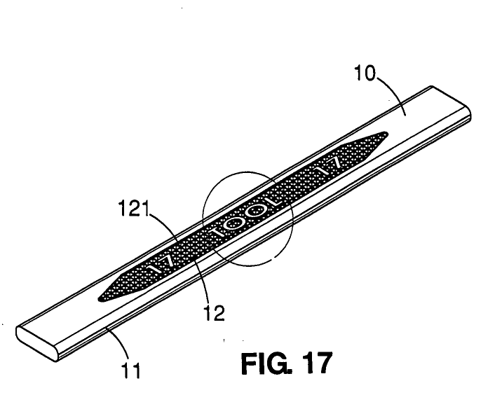

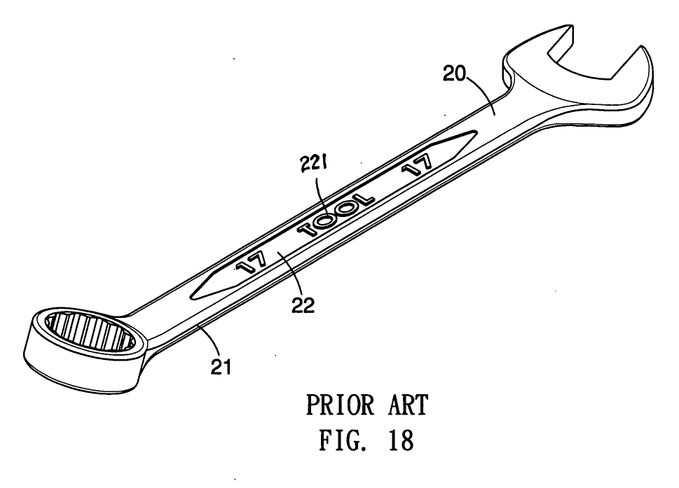

Referring to FIG. 17, the present invention is emphasizing the grip 11 of the wrench 10, types of driving heads adopted at the two ends of the grip 11 are not specified, i.e. the driving heads can be open type, box type or with ratchet wheels.

In summary of the present invention, the surface treatment applied to the whole set of the wrench made the wrench has either reflexible surface or non-reflexible surface, the sunken area 12 is full of intensive plurality of knurls 121 which surround the embossed mark 122, therefore the embossed mark 122 is outstanding and visual identification. Through design the mark area can have various graphs to increase the visual beauty meanwhile the purpose of comfort and firmness in grip is achieved.

1. A wrench comprising
a grip with two ends and a longitudinal axis which extends to the both ends;
at least one end is a driving head; and
at least one mark area is on the surface of the grip, the mark area includes a sunken area wherein intensive plurality of knurls is implemented therein and at least one embossed mark is established therein, wherein the plurality of knurls is formed by press forming, the area of an individual part of the embossed mark is larger than the area of top of each knurl, and the embossed mark being adjacently surrounded with the intensive plurality of knurls is visually outstanding.

2. (canceled)

3. The wrench as described in claim 1, wherein both of the two ends of the grip are driving heads.

4. The wrench as described in claim 3, wherein one driving head is an open end; the other driving head is a box end.

5. The wrench as described in claim 1, wherein the grip is flat and wide with two flat grip surfaces and at least one of the two flat grip surfaces has at least one mark area.

6. (canceled)

7. (canceled)

8. (canceled)

9. The wrench as described in claim 1, wherein the top of the knurl and the surface of the grip are in same level.

10. The wrench as described in claim 1, wherein the embossed mark inside of the sunken area can be letter, symbol or graph.

11. The wrench as described in claim 1, wherein the top of the embossed mark and the surface of the grip are in same level.

12. The wrench as described in claim 1, wherein each knurl is in striped shape.

13. (canceled)

14. (canceled)

15. The wrench as described in claim 1, wherein the cross section of the grip is shaped oval.

16. The wrench as described in claim 1, wherein the cross section of the sunken area is a concaved curve.

17. The wrench as described in claim 1, wherein there are at least two mark areas on the surface of the grip.

18. The wrench as described in claim 1, wherein there are three mark areas on the surface of the grip.

19. The wrench as described in claim 1, wherein the grip is flat and wide with two flat grip surfaces, and the mark area extends onto both grip surfaces.

20-26. (canceled)

27. A wrench comprising:
a grip with two ends and a longitudinal axis which extends to the two ends;
at least one end is a driving head; and
at least one mark area is on the surface of the grip, the mark area includes a sunken area wherein intensive plurality of knurls is implemented therein and at least one embossed mark is established therein, wherein the plurality of knurls is formed by press forming, the cross section of the sunken area is a concaved curve, and the embossed mark being surrounded and adjacent with the intensive plurality of knurls is visually outstanding.

28. The wrench as described in claim 27, wherein the grip has two wide surfaces, and the mark area extends onto at least one wide surface.

29. The wrench as described in claim 27, wherein the grip has two wide surfaces, and the mark area extends onto both wide surfaces.

30. A wrench comprising;
a grip with two ends and a longitudinal axis which extends to the two ends;
at least one end is a driving head; and
at least one mark area is on the surface of the grip, the mark area includes a sunken area wherein intensive plurality of knurls is implemented therein and at least one embossed mark is established therein, wherein the plurality of knurls is formed by press forming, the embossed mark being surrounded and adjacent with the intensive plurality of knurls is visually outstanding, the top of the embossed mark and the surface of the grip are in same level, the grip is flat and has two wide flat surfaces, and at least one of the flat surfaces has at least one mark area.

31. The wrench as described in claim 30, wherein each of the plurality knurl is in striped shape.
